(19) United States
(12) Patent Application Publication
(10) Pub. No.: US 2017/0165799 A1
(43) Pub. Date: Jun. 15, 2017

(54) MACHINE TOOL AND FEED SADDLE STRUCTURE THEREOF

(71) Applicant: INDUSTRIAL TECHNOLOGY RESEARCH INSTITUTE, Hsinchu Hsien (TW)

(72) Inventors: Wei-Jun Lin, Hsinchu (TW); Chien-Chih Liao, Hsinchu (TW); Shuo-Peng Liang, Hsinchu (TW)

(21) Appl. No.: 14/967,628

(22) Filed: Dec. 14, 2015

(51) Int. Cl. B23Q 1/62; B23Q 1/01

(52) U.S. Cl. CPC B23Q 1/621; B23Q 1/015

(57) ABSTRACT

A machine tool and a feed saddle structure thereof are provided. The feed saddle structure includes: a fixed column having a first vertical side and a horizontal side adjacent to the first vertical side; a feed saddle having a second vertical side corresponding in position to the first vertical side of the fixed column, and a bottom portion being adjacent to the second vertical side and corresponding in position to the horizontal side of the fixed column; a first guide rail and a second guide rail disposed on the first vertical side and the horizontal side of the fixed column, respectively; and a first slider and a second slider disposed on the second vertical side and the bottom portion of the feed saddle, respectively, and engaged with the first guide rail and the second guide rail, respectively, thereby increasing the dynamic and static rigidity of the machine tool.

### BACKGROUND OF THE DISCLOSURE

1. Technical Field

The present disclosure relates to machine tools and feed saddle structures thereof, and, more particularly, to a machine tool and a feed saddle structure thereof having a plurality of guide rails.

2. Description of Related Art

In a conventional four-axis or five-axis machine tool (first type), a spindle head is disposed on a moving column for movement, and the moving column is supported and moved by two horizontal guide rails positioned under a bottom portion of the moving column.

However, the moving column of the above-described first type machine tool is quite long, and the two horizontal guide rails are positioned far away from the spindle head, thus reducing the rigidity of the machine tool. Accordingly, a machine tool having a short moving column (second type) is developed to increase the rigidity of the machine tool and the bending strength of the spindle head.

To improve the dynamic performance of the machine tool during a feed operation, a third type machine tool having the two horizontal guide rails positioned at different height levels is provided, and the mass and inertia of the moving column are reduced.

As the workpiece (or product) cycle is becoming shorter and shorter, the machining efficiency of the machine tool must be increased continuously. Accordingly, the feed rate and acceleration of the machine tool are increased. However, the third type machine tool cannot meet such a high response feed system. Therefore, a machine tool having a fixed column and three vertical guide rails is proposed (fourth type) to overcome the above-described drawbacks, achieve the shortest force flow and greatly reduce the weight of moving parts of the machine tool.

However, in the fourth type machine tool, the three vertical guide rails are disposed on a vertical side of the fixed column, thus resulting in poor support force of the fixed column and poor bending strength of the spindle head and headstock and hence reducing the dynamic and static rigidity of the machine tool.

Therefore, how to overcome the above-described drawbacks has become critical.

### SUMMARY

The present disclosure provides a machine tool and a feed saddle structure thereof so as to increase the dynamic and static rigidity of the machine tool.

The machine tool according to the present disclosure comprises: a headstock; and a feed saddle structure for carrying and moving the headstock, comprising: a fixed column having a first vertical side and a horizontal side being adjacent to the first vertical side; a feed saddle having a second vertical side corresponding in position to the first vertical side of the fixed column, and a bottom portion adjacent to the second vertical side and corresponding in position to the horizontal side of the fixed column; at least one first guide rail and at least one second guide rail disposed on the first vertical side and the horizontal side of the fixed column, respectively; and at least one first slider and at least one second slider disposed on the second vertical side and the bottom portion of the feed saddle respectively, and engaged with the first guide rail and the second guide rail, respectively.

The feed saddle structure of a machine tool according to the present disclosure comprises: a fixed column having a first vertical side and a horizontal side adjacent to the first vertical side; a feed saddle having a second vertical side corresponding in position to the first vertical side of the fixed column, and a bottom portion being adjacent to the second vertical side and corresponding in position to the horizontal side of the fixed column; at least one first guide rail and at least one second guide rail disposed on the first vertical side and the horizontal side of the fixed column, respectively; and at least one first slider and at least one second slider disposed on the second vertical side and the bottom portion of the feed saddle, respectively, and engaged with the first guide rail and the second guide rail, respectively.

According to the present disclosure, at least one first guide rail and at least one second guide rail are disposed on a first vertical side and a horizontal side of a fixed column, respectively. Also, at least one first slider and at least one second slider are disposed on a second vertical side and a bottom portion of a feed saddle, respectively, and engaged with the first guide rail and the second guide rail, respectively. Therefore, the present disclosure increases the support force of the fixed column, improves the carrying capability of the feed saddle structure, and increases the dynamic and static rigidity of the machine tool.

Further, since the second guide rail and the second slider are disposed on the horizontal side of the fixed column and the bottom portion of the feed saddle and engaged with each other, the horizontal side of the fixed column and the second guide rail can provide a large support force. As such, the feed saddle structure has improved capability to carry components such as a feed saddle and a headstock, and the bending strength of the components (such as the headstock) and the dynamic and static rigidity of the machine tool are increased.

### BRIEF DESCRIPTION OF DRAWINGS

FIGS. 1A and 1B are schematic front and side views of a machine tool and a feed saddle structure thereof according to a first embodiment of the present disclosure;

FIG. 2 is a schematic side view of the machine tool and the feed saddle structure thereof according to a second embodiment of the present disclosure;

FIG. 3 is a schematic side view of the machine tool and the feed saddle structure thereof according to a third embodiment of the present disclosure;

FIG. 4 is a schematic side view of the machine tool and the feed saddle structure thereof according to a fourth embodiment of the present disclosure;

FIG. 5 is a schematic side view of the machine tool and the feed saddle structure thereof according to a fifth embodiment of the present disclosure;

FIG. 6 is a schematic side view of the machine tool and the feed saddle structure thereof according to a sixth embodiment of the present disclosure;

FIG. 7A is a graph showing dynamic frequency response along an X-axis of the machine tool according to the present disclosure;

FIG. 7B is a graph showing dynamic frequency response along a Y-axis of the machine tool according to the present disclosure; and

FIG. 7C is a graph showing dynamic frequency response along a Z-axis of the machine tool according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

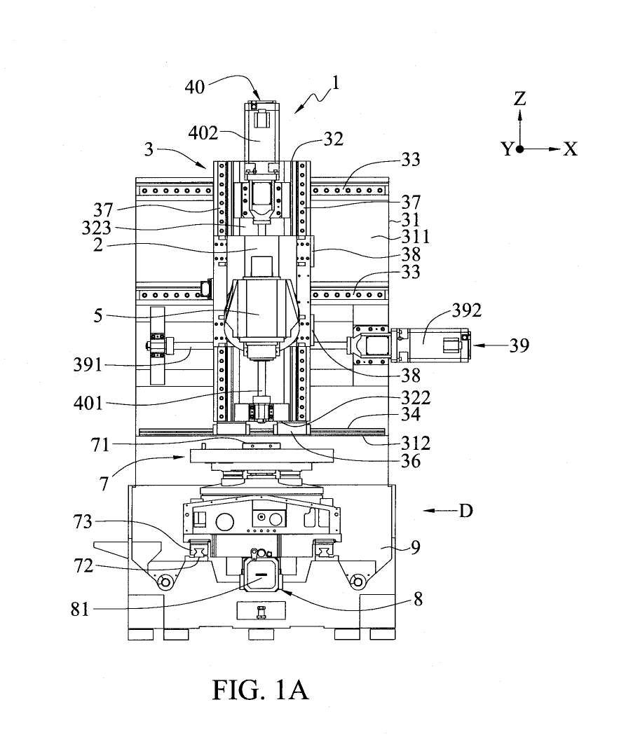

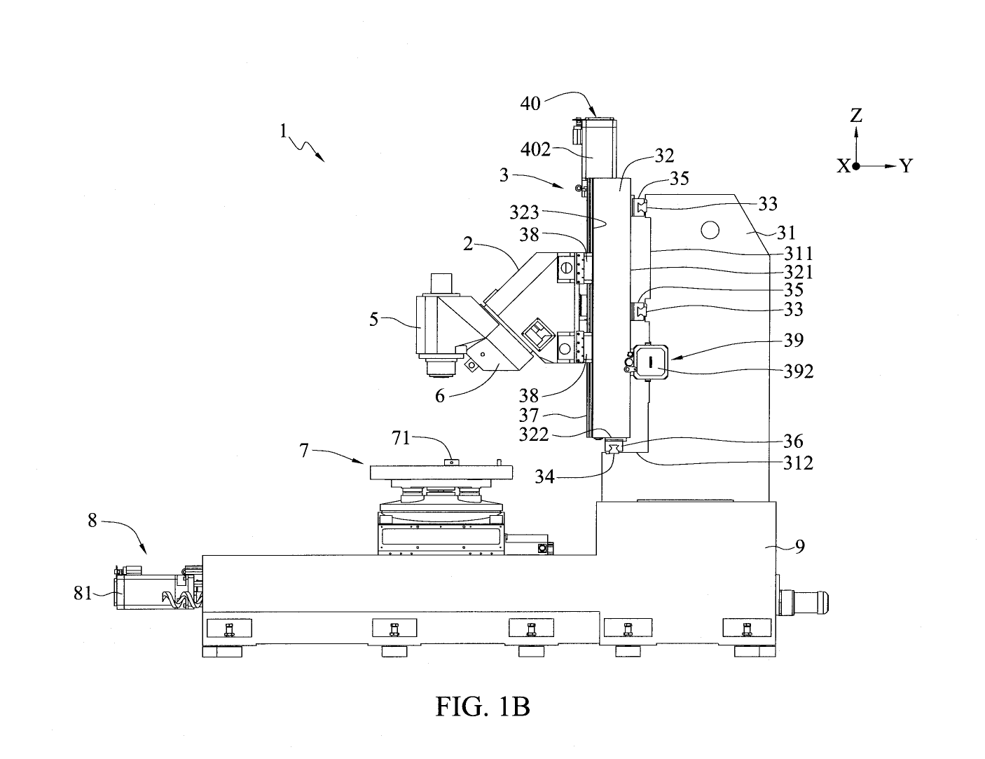

FIG. 1A is a schematic front view of a machine tool 1 and a feed saddle structure 3 of the machine tool 1 according to a first embodiment of the present disclosure. FIG. 1B is a schematic side view of the machine tool 1 and the feed saddle structure 3 of the machine tool 1 along a direction D. The machine tool 1 has a headstock 2 and a feed saddle structure 3 for carrying and moving components such as the headstock 2.

The feed saddle structure 3 has a fixed column 31, a feed saddle 32, two first guide rails 33, a second guide rail 34, two first sliders 35, and a second slider 36.

The fixed column 31 has a first vertical side 311 (along a Z-axis) and a horizontal side 312 (along an X-axis) adjacent to the first vertical side 311. The horizontal side 312 of the fixed column 31 is positioned at a lower portion of the first vertical side 311 and perpendicular to the first vertical side 311. As such, the first vertical side 311 and the horizontal side 312 of the fixed column 31 form an L-shape or substantially L-shape configuration.

The feed saddle 32 has a second vertical side 321 (along the Z-axis) and a bottom portion 322 (along the X-axis) adjacent to the second vertical side 321. The second vertical side 321 of the feed saddle 32 is parallel and corresponds in position to the first vertical side 311 of the fixed column 31, and the bottom portion 322 of the feed saddle 32 is parallel and corresponds in position to the horizontal side 312 of the fixed column 31.

The two first guide rails 33 are disposed on the first vertical side 311 of the fixed column 31, the second guide rail 34 is disposed on the horizontal side 312 of the fixed column 31, and the two first guide rails 33 and the second guide rail 34 are parallel to the horizontal side 312 of the fixed column 31. In an embodiment, the two first guide rails 33 are disposed on upper and middle portions of the first vertical side 311 of the fixed column 31, respectively.

The two first sliders 35 are disposed on the second vertical side 321 of the feed saddle 35 and respectively engaged with the two first guide rails 33, and the second slider 36 is disposed on the bottom portion 322 of the feed saddle 32 and engaged with the second guide rail 34. In an embodiment, the two first sliders 35 are disposed on upper and middle portions of the second vertical side 321 of the feed saddle 32.

The feed saddle structure 3 further has a first feed device 39 disposed below or between the two first guide rails 33 (the two first sliders 35) and having a first screw 391 and a first motor 392. The first screw 391 is positioned between the first vertical side 311 of the fixed column 31 and the second vertical side 321 of the feed saddle 32 and parallel to the two first guide rails 33 and the second guide rail 34. As such, the first motor 392 drives the first screw 391 to cause the feed saddle 32 to move horizontally on the two first guide rails 33 and the second guide rail 34 along the X-axis (horizontal feed).

The feed saddle 32 further has a third vertical side 323 (along the Z-axis) opposite to the second vertical side 321. The feed saddle structure 3 further has two third guide rails 37 disposed on the third vertical side 323 and four third sliders 38 disposed on the headstock 2 (for example, at four corners of the headstock 2) and engaged with the two third guide rails 37. In another embodiment, at least two third sliders 38 are provided.

The feed saddle structure 3 further has a second feed device 40 having a second screw 401 and a second motor 402. The second screw 401 of the second feed device 40 is positioned between the third vertical side 323 of the feed saddle 32 and the headstock 2 and possibly between the two third guide rails 37 and parallel to the two third guide rails 37. As such, the second motor 402 drives the second screw 401 to cause the headstock 2 to move vertically on the two third guide rails 37 along the Z-axis (vertical feed).

The machine tool 1 can be a four-axis machine tool having a spindle head 5 disposed on the headstock 2, and the spindle head 5 and the headstock 2 are carried and moved by the feed saddle structure 3. Alternatively, the machine tool 1 can be a five-axis machine tool having a rotating device 6 disposed on the headstock 2 and a spindle head 5 disposed on the rotating device 6, and the spindle head 5, the rotating device 6 and the headstock 2 are carried and moved by the feed saddle structure 3. The rotating device 6 can rotate with a predetermined angle (such as 45 degree) so as to cause the spindle head 5 to rotate with the predetermined angle.

The machine tool 1 further has a bench 7. A workpiece 71 is disposed on the bench 7 at a position corresponding to the spindle head 5 so as to be processed by the spindle head 5.

The machine tool 1 further has two fourth guide rails 72 and at least two fourth sliders 73 disposed below the bench 7 or on a horizontal side of the bench 7 (along a Y-axis) and engaged with the two fourth guide rails 72.

The machine tool 1 further has a third feed device 8 having a third screw (not shown) and a third motor 81. The third screw is positioned between the two fourth guide rails 72 and parallel to the two fourth guide rails 72. As such, the third motor 81 drives the third screw to cause the bench 7 and the workpiece 71 to move horizontally on the two fourth guide rails 72 along the Y-axis (horizontal feed).

The machine tool 1 further has a base 9, and the fixed column 31, the bench 7 and the two fourth guide rails 72 are disposed on the base 9. The fixed column 31 is fixed on the base 9 through fastening elements such as bolts (not shown).

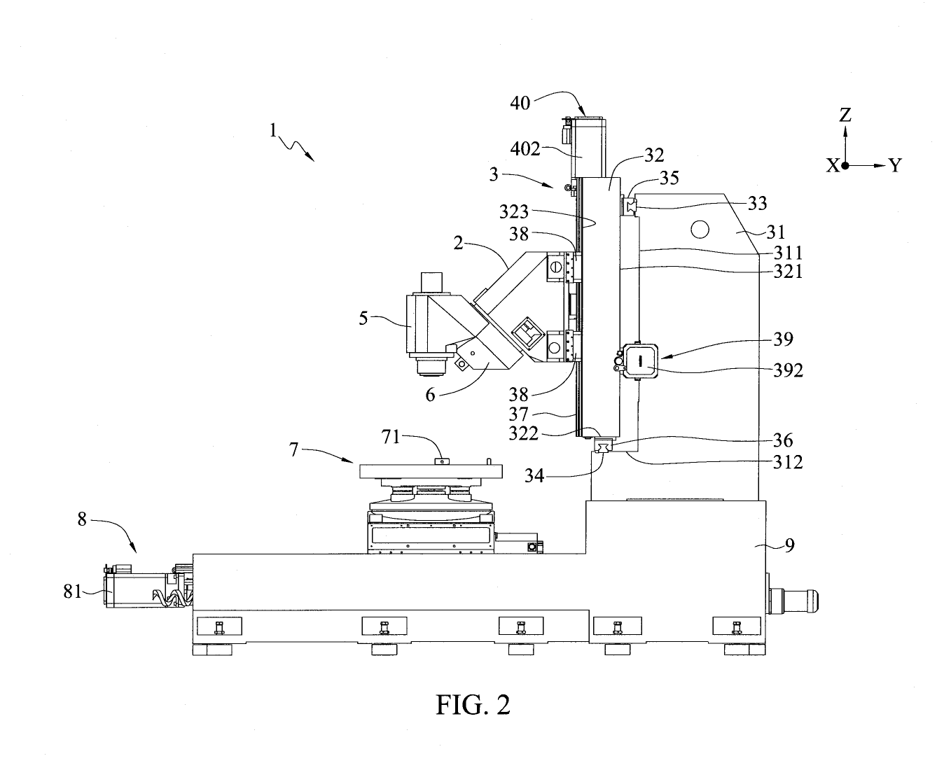

FIG. 2 is a schematic side view of the machine tool 1 and the feed saddle structure 3 according to a second embodiment of the present disclosure. The difference of the second embodiment from the first embodiment is detailed as follows.

Referring to FIG. 2, the feed saddle structure 3 has only one first guide rail 33 positioned on an upper portion of the first vertical side 311 of the fixed column 31 and one first slider 35 positioned on an upper portion of the second vertical side 321 of the feed saddle 32 and engaged with the first guide rail 33.

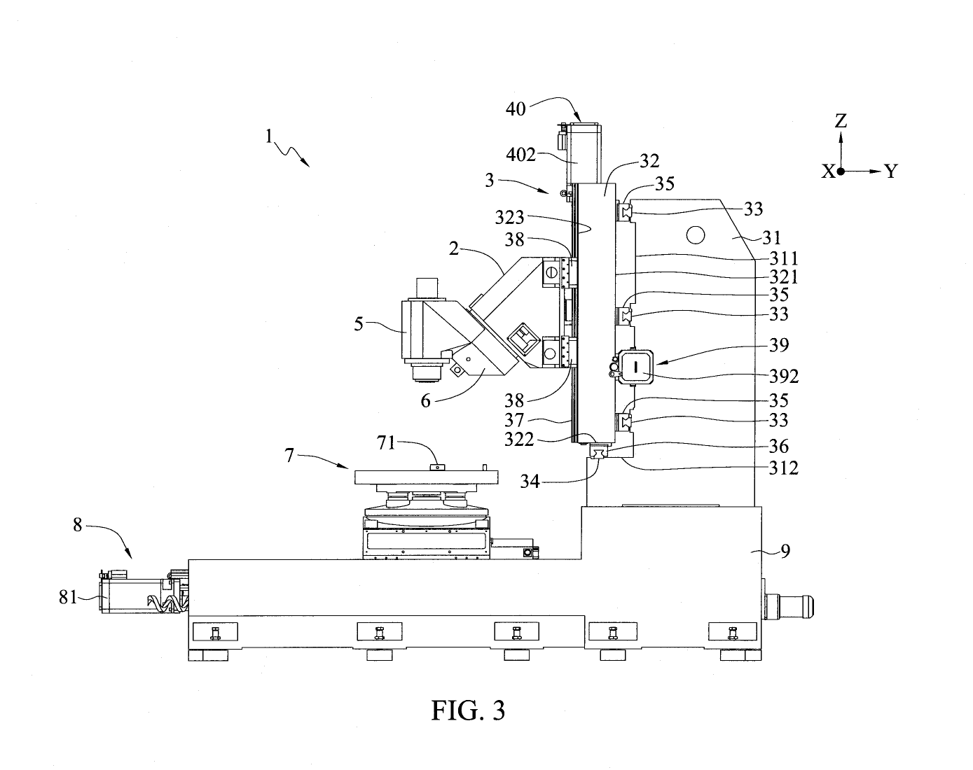

FIG. 3 is a schematic side view of the machine tool 1 and the feed saddle structure 3 according to a third embodiment of the present disclosure. The difference of the third embodiment from the first embodiment is detailed as follows.

Referring to FIG. 3, the feed saddle structure 3 has three first guide rails 33 positioned on upper, middle and lower portions of the first vertical side 311 of the fixed column 31, respectively, and three first sliders 35 respectively positioned on upper, middle and lower portions of the second vertical side 321 of the feed saddle 32 and respectively engaged with the three first guide rails 33.

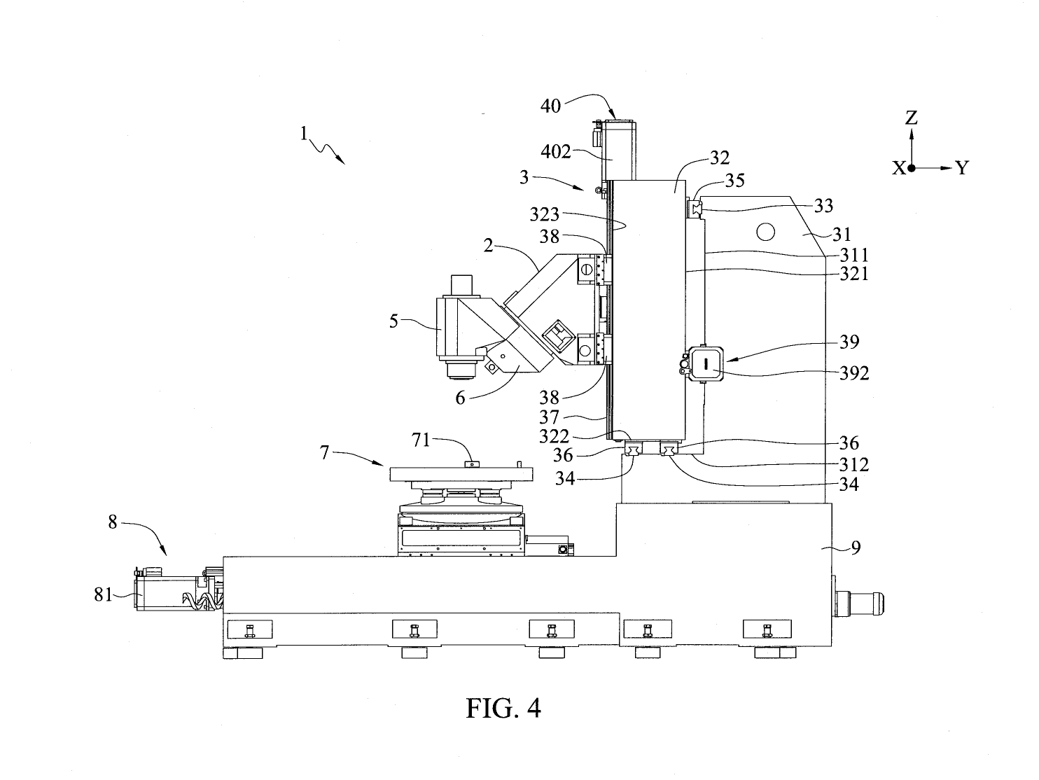

FIG. 4 is a schematic side view of the machine tool 1 and the feed saddle structure 3 according to a fourth embodiment of the present disclosure. The difference of the fourth embodiment from the first embodiment is detailed as follows.

Referring to FIG. 4, the feed saddle structure 3 has only one first guide rail 33 positioned on an upper portion of the first vertical side 311 of the fixed column 31 and one first slider 35 positioned on an upper portion of the second vertical side 321 of the feed saddle 32 and engaged with the first guide rail 33.

Further, the feed saddle structure 3 has two second guide rails 34 and two second sliders 36 engaged with the second guide rails 34. The area of the horizontal side 312 of the fixed column 31 of FIG. 4 is greater than the area of the horizontal side 312 of the fixed column 31 of FIG. 1B, and the area of the bottom portion 322 of the feed saddle 32 of FIG. 4 is greater than the area of the bottom portion 322 of the feed saddle 32 of FIG. 1B, thus allowing the two second guide rails 34 and the two second sliders 36 to be disposed on the horizontal side 312 of the fixed column 31 and the bottom portion 322 of the feed saddle 32, respectively.

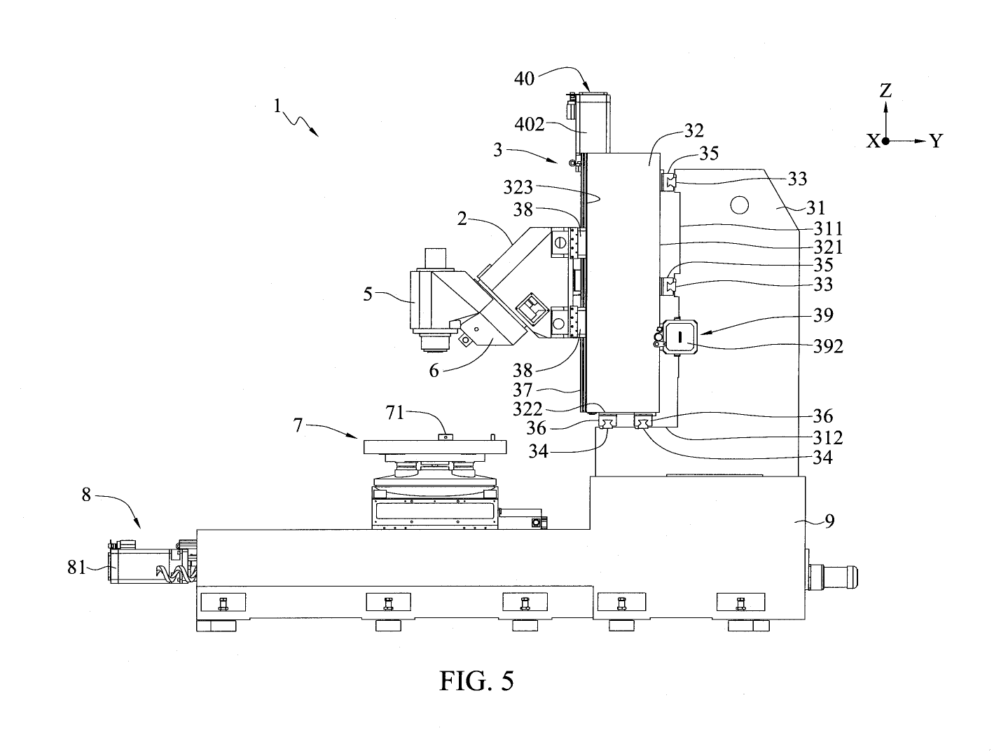

FIG. 5 is a schematic side view of the machine tool 1 and the feed saddle structure 3 according to a fifth embodiment of the present disclosure. The difference of the fifth embodiment from the first embodiment is detailed as follows.

Referring to FIG. 5, the feed saddle structure 3 has two second guide rails 34 and two second sliders 36 engaged with the two second guide rails 34. The area of the horizontal side 312 of the fixed column 31 of FIG. 5 is greater than the area of the horizontal side 312 of the fixed column 31 of FIG. 1B, and the area of the bottom portion 322 of the feed saddle 32 of FIG. 5 is greater than the area of the bottom portion 322 of the feed saddle 32 of FIG. 1B, thus allowing the two second guide rails 34 and the two second sliders 36 to be disposed on the horizontal side 312 of the fixed column 31 and the bottom portion 322 of the feed saddle 32, respectively.

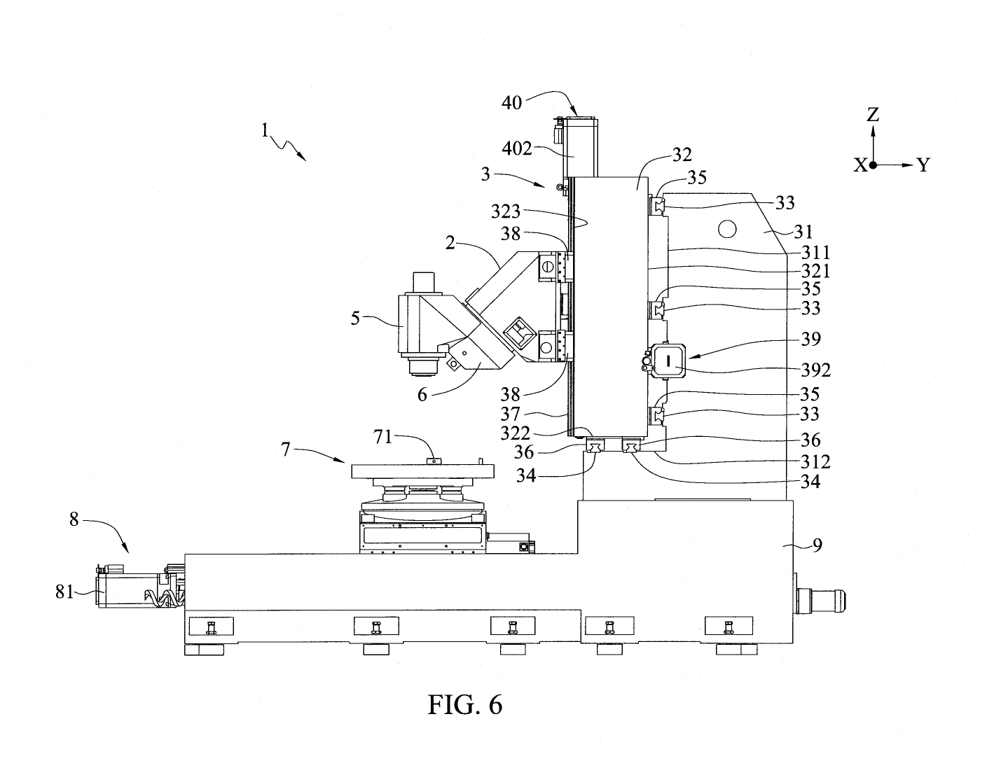

FIG. 6 is a schematic side view of the machine tool 1 and the feed saddle structure 3 according to a sixth embodiment of the present disclosure. The difference of the sixth embodiment from the first embodiment is detailed as follows.

Referring to FIG. 6, the feed saddle structure 3 has three first guide rails 33 positioned on upper, middle and lower portions of the first vertical side 311 of the fixed column 31, respectively, and three first sliders 35 respectively positioned on upper, middle and lower portions of the second vertical side 321 of the feed saddle 32 and respectively engaged with the three first guide rails 33.

Further, the feed saddle structure 3 has two second guide rails 34 and two second sliders 36 engaged with the two second guide rails 34. The area of the horizontal side 312 of the fixed column 31 of FIG. 6 is greater than the area of the horizontal side 312 of the fixed column 31 of FIG. 1B, and the area of the bottom portion 322 of the feed saddle 32 of FIG. 6 is greater than the area of the bottom portion 322 of the feed saddle 32 of FIG. 1B, thus allowing the two second guide rails 34 and the two second sliders 36 to be disposed on the horizontal side 312 of the fixed column 31 and the bottom portion 322 of the feed saddle 32, respectively.

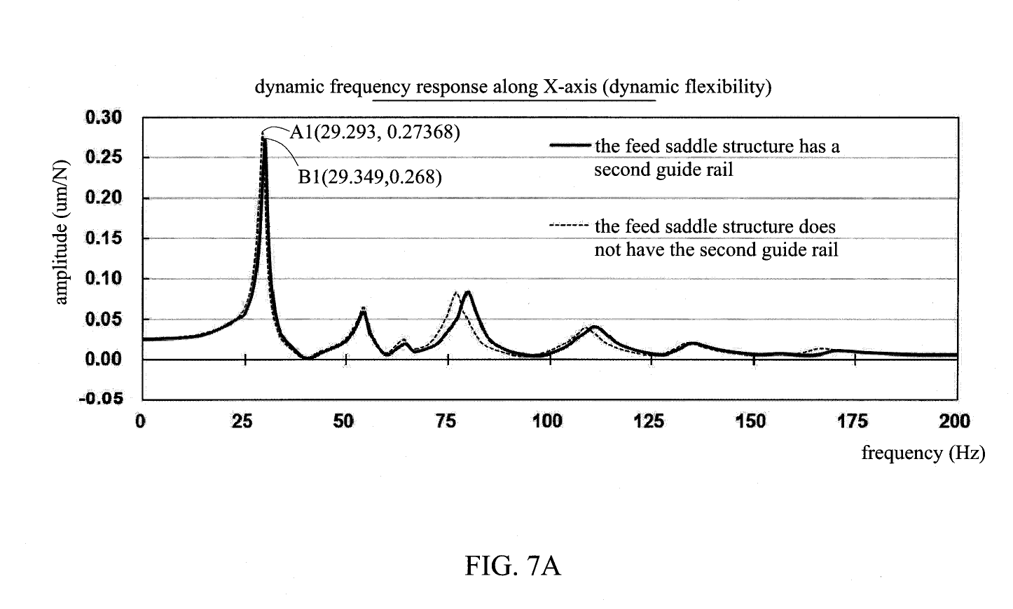

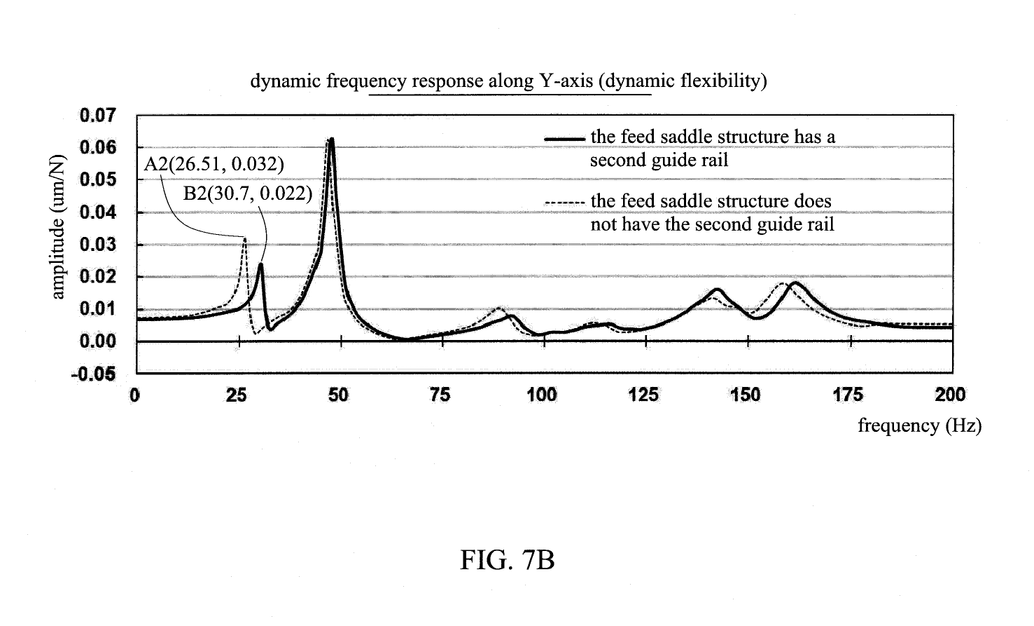

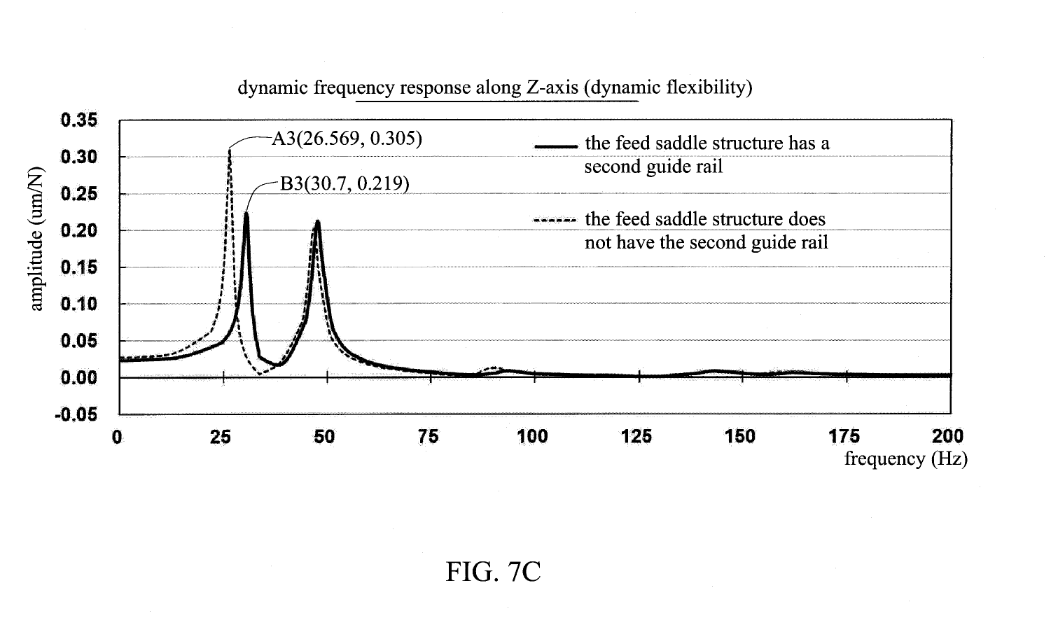

FIG. 7A is a graph showing dynamic frequency response (dynamic flexibility) along the X-axis of the machine tool 1 according to the present disclosure. FIG. 7B is a graph showing dynamic frequency response along the Y-axis of the machine tool 1 according to the present disclosure. FIG. 7C is a graph showing dynamic frequency response along the Z-axis of the machine tool 1 according to the present disclosure. FIGS. 7A to 7C are test results of the machine tool 1 of FIG. 3.

Referring to FIGS. 7A to 7C, a solid-line curve represents a test result of the machine tool 1 of FIG. 3, and a dotted-line curve represents a test result of the machine tool 1 that dispenses with the second guide rail 34 and the second slider 36.

Referring to FIG. 7A, in the case that the feed saddle structure 3 does not have the second guide rail 34 and the second slider 36, the frequency and amplitude at a point A1 of the dotted-line curve is 29.293 Hz and 0.27368 um/N. In the case that the feed saddle structure 3 has the second guide rail 34 and the second slider 36, the frequency and amplitude at a point B1 of the solid-line curve is 29.349 Hz and 0.268 um/N. Therefore, the dynamic flexibility (amplitude) of the machine tool 1 of FIG. 3 is reduced by about 2% ((0.268−0.27368)÷0.27368=−0.02). Therefore, the dynamic rigidity of the machine tool 1 is increased by about 2%. The dynamic rigidity is the reciprocal of the dynamic flexibility.

Referring to FIG. 7B, in the case that feed saddle structure 3 does not have the second guide rail 34 and the second slider 36, the frequency and amplitude at a point A2 of the dotted-line curve is 26.51 Hz and 0.032 um/N. On the other hand, in the case that the feed saddle structure 3 has the second guide rail 34 and the second slider 36, the frequency and amplitude at a point B2 of the solid-line curve is 30.7 Hz and 0.022 um/N. Therefore, the dynamic flexibility (amplitude) of the machine tool 1 of FIG. 3 is reduced by about 31% ((0.022−0.032)÷0.032=−0.31). That is, the dynamic rigidity of the machine tool 1 is increased by about 31%.

Referring to FIG. 7C, in the case that feed saddle structure 3 has the second guide rail 34 and the second slider 36, the frequency and amplitude at a point A3 of the dotted-line curve is 25.569 Hz and 0.305 um/N. On the other hand, in the case that the feed saddle structure 3 has the second guide rail 34 and the second slider 36, the frequency and amplitude at a point B3 of the solid-line curve is 30.7 Hz and 0.219 um/N. Therefore, the dynamic flexibility (amplitude) of the machine tool 1 of FIG. 3 is reduced by about 28% ((0.219−0.305)÷0.305=−0.28). That is, the dynamic rigidity of the machine tool 1 is increased by about 28%.

According to the test results of the machine tool 1 of FIG. 3, the static rigidity along the X-axis of the machine tool 1 is increased by about 2.7%, the static rigidity along the Y-axis of the machine tool 1 is increased by about 6.2%, and the static rigidity along the Z-axis of the machine tool 1 is increased by about 13.95%.

It should be noted that the above test results are only examples and may vary with different frequencies (positional points) and different number of the first guide rails 33 (the first slider 35) and the second guide rails 34 (the second sliders 36).

According to the present disclosure, at least one first guide rail and at least one second guide rail are disposed on a first vertical side and a horizontal side of a fixed column, respectively, and at least one first slider and at least one second slider are respectively disposed on a second vertical side and a bottom portion of a feed saddle and respectively engaged with the first guide rail and the second guide rail. Therefore, the present disclosure increases the support force of the fixed column, improves the carrying capability of the feed saddle structure and increases the dynamic and static rigidity of the machine tool.

Further, since the second guide rail and the second slider are disposed on the horizontal side of the fixed column and the bottom portion of the feed saddle and engaged with one another, the horizontal side of the fixed column and the second guide rail can provide a large support force. As such, the feed saddle structure has improved capability to carry components such as a feed saddle, a headstock and a spindle head (and a rotating device), and the bending strength of the components such as the headstock and the spindle head (and the rotating device) and the dynamic and static rigidity of the machine tool are increased.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A machine tool, comprising:
a headstock; and
a feed saddle structure configured to carry and move the headstock, and comprising:
a fixed column having a first vertical side and a horizontal side adjacent to the first vertical side;
a feed saddle having a second vertical side and a bottom portion, the second vertical side corresponding in position to the first vertical side of the fixed column, and the bottom portion being adjacent to the second vertical side and corresponding in position to the horizontal side of the fixed column;
at least one first guide rail and at least one second guide rail disposed on the first vertical side and the horizontal side of the fixed column, respectively; and
at least one first slider and at least one second slider disposed on the second vertical side and the bottom portion of the feed saddle, respectively, and engaged with the first guide rail and the second guide rail, respectively.

2. The machine tool of claim 1, wherein the number of the at least first guide rail is two and the number of the at least one first slider is two.

3. The machine tool of claim 1, wherein the number of the at least one second guide rail is one and the number of the at least one second slider is one.

4. The machine tool of claim 1, wherein the feed saddle structure further comprises a first feed device having a first screw positioned at the first vertical side of the fixed column and configured to drive the feed saddle to move on the first guide rail and the second guide rail.

5. The machine tool of claim 1, wherein the feed saddle structure further comprises two third guide rails disposed on a third vertical side of the feed saddle, and at least two third sliders disposed on the headstock and engaged with the two third guide rails.

6. The machine tool of claim 5, wherein the feed saddle structure further comprises a second feed device having a second screw positioned at the third vertical side and being parallel to the two third guide rails, and configured to drive the headstock to move on the two third guide rails.

7. A feed saddle structure of a machine tool, comprising:
a fixed column having a first vertical side and a horizontal side adjacent to the first vertical side;
a feed saddle having a second vertical side and a bottom portion, the second vertical side corresponding in position to the first vertical side of the fixed column, and the bottom portion being adjacent to the second vertical side and corresponding in position to the horizontal side of the fixed column;
at least one first guide rail and at least one second guide rail disposed on the first vertical side and the horizontal side of the fixed column, respectively; and
at least one first slider and at least one second slider disposed on the second vertical side and the bottom portion of the feed saddle, respectively, and engaged with the first guide rail and the second guide rail, respectively.

8. The feed saddle structure of claim 7, wherein the number of the at least one first guide rail is two and the number of the at least one first slider is two.

9. The feed saddle structure of claim 7, wherein the number of the at least one second guide rail is one and the number of the at least one second slider is one.

10. The feed saddle structure of claim 7, further comprising a first feed device having a first screw positioned at the first vertical side of the fixed column and configured to drive the feed saddle to move on the first guide rail and the second guide rail.

11. The feed saddle structure of claim 7, further comprising two third guide rails disposed on a third vertical side of the feed saddle, and at least two third sliders disposed on a headstock of the machine tool and engaged with the two third guide rails.

12. The feed saddle structure of claim 11, further comprising a second feed device having a second screw positioned at the third vertical side and being parallel to the two third guide rails, and configured to drive the headstock to move on the two third guide rails.
